(19) United States
(12) Patent Application Publication
(10) Pub. No.: US 2017/0095949 A1
(43) Pub. Date: Apr. 6, 2017

(54) A MOULD TOOL FOR INJECTION MOULDING

(71) Applicant: LEGO A/S, Billund (DK)

(72) Inventors: Jens Stamp LAMBÆK, Ikast (DK); Steen Bruno Nedergaard JENSEN, Odense SV (DK)

(21) Appl. No.: 15/311,957

(22) PCT Filed: May 28, 2015
(86) PCT No.: PCT/DK2015/050137

§ 371 Date: Nov. 18, 2016

(30) Foreign Application Priority Data
May 28, 2014 (DK) PA 2014 70308

(51) Int. Cl. B29C 33/48; B29C 45/26

(52) U.S. Cl. CPC B29C 33/48; B29C 45/2602; B29C 2045/2604

(57) ABSTRACT

An injection-moulding mould comprising at least three separate mould parts (1,2,3), comprising an inlet mould part (1) in which is arranged an inlet for injection of liquid plastics from the injection-moulding apparatus, a closing mould part (2) and at least one intermediate mould part (3) arranged between the inlet mould part and the closing mould part, and wherein, between the inlet mould part (1) and the intermediate mould part (2), a distance-limiting device (7) is configured having an end stop (12) configured with a view to limiting the distance by which the intermediate mould plate (2) can be shifted away from the inlet mould part (1), and wherein a shock absorber (6) is further arranged between the inlet mould part (1) and the intermediate mould part (2), said shock absorber (6) being configured such that it mitigates the shifting movement between the inlet mould part (1) and the intermediate mould part (2), when they are shifted away each other and before the end stop (12) is hit.

### PRIOR ART

The present invention relates to an injection-moulding mould configured for being mounted in an injection-moulding apparatus for automated moulding of work pieces from plastics, said injection-moulding mould comprising at least three separate mould parts, comprising an inlet mould part in which is arranged an inlet for injection of liquid plastics from the injection-moulding apparatus, a closing mould part and at least one intermediate mould part arranged between the inlet mould part and the closing mould part, and which mould parts in pairs are separated by mould separation faces and are configured for being capable of being shifted relative to each other along a straight line which is substantially at right angles to the mould separation faces which, in the closed state of the injection-moulding mould where the mould separation faces are in abutment on each other, form a number of mould cavities and, in the open state of the injection-moulding mould where the mould separation faces are pulled away from each other, allow form removal of work pieces moulded in the mould cavities, and wherein, between the inlet mould part and the intermediate mould part, a distance-limiting device is configured that has an end stop configured with a view to limiting the distance by which the intermediate mould plate can be shifted away from the inlet mould part.

Such injection-moulding mould in known from eg DE patent application No. 37 16 796.

### OBJECT OF THE INVENTION

It is the object of the present invention to provide an injection-moulding mould of the kind set forth above, whereby a reduced cycle time for the injection moulding process between each moulding process is enabled.

This is accomplished by the invention as set forth in claim 1; it being thereby accomplished that the shock absorber mitigates the shifting movement of the intermediate mould part away from the inlet mould part briefly before the end stop of the distance-limiting device is hit whereby it is enabled that the injection-moulding mould can be opened faster without there being thereby transmitted a large force impact to the two mould parts with therefrom ensuing increased wear and noise.

According to a preferred embodiment, the shock absorber is interconnected with the distance-limiting device whereby it can be assembled and mounted on the injection-moulding mould as an integral unit.

In the context of this, the distance-limiting device may, according to a simple embodiment, comprise an outer pipe and a rod being arranged to be telescopically displaceable within the outer pipe.

Besides, the shock absorber may conveniently be arranged to be protected within the outer pipe.

According to a further preferred embodiment, the injection-moulding mould further comprises a shock absorber arranged between the closing mould part and the intermediate mould part, said shock absorber being configured such that it mitigates the shifting movement between the closing mould part and the intermediate mould part, when they are moved towards each other and only briefly before the injection-moulding mould is closed. Thereby a further reduced production cycle time is accomplished, it being possible to increase the speed by which the mould parts can be closed without it entailing increased wear or noise.

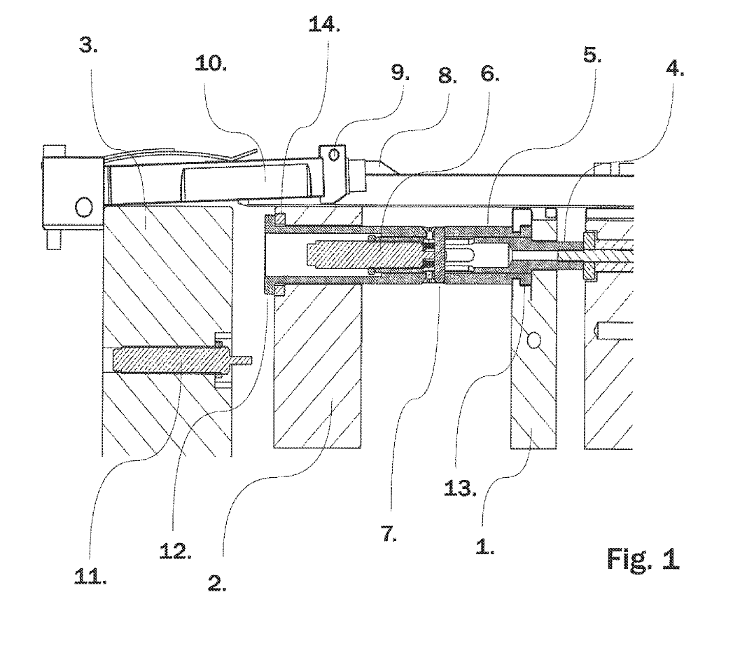

FIG. 1: is a sectional view showing a part of an assembled injection-moulding mould comprising a distance-limiting device with a shock absorber according to the invention.

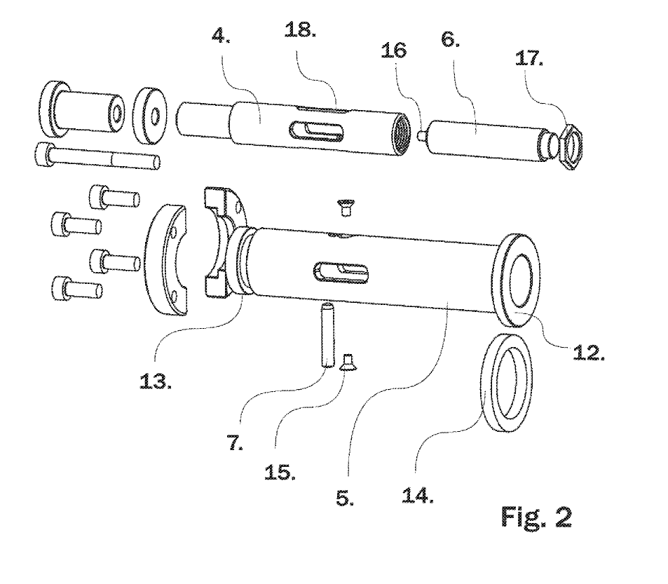

FIG. 2: is an exploded view showing the constituent components of the distance-limiting device with shock absorber shown in FIG. 1.

### DESCRIPTION OF AN EMBODIMENT

Thus, FIG. 1 shows a sectional view through a part of an injection-moulding mould according to the invention, with an essentially stationary inlet mould part 1, an intermediate mould part 2 and a closing mould part 3. In the figure, the three mould parts are shifted away from each other to the effect that the injection-moulding mould is open for removal of any moulded work pieces (not shown) from mould cavities that are thereby open into the space between the closing mould part 3 and the intermediate mould part 2 and moulded distributor elements, corresponding to not shown distribution channels that are thereby open into the space between the inlet mould part 1 and the intermediate mould part 2.

In FIG. 1, the intermediate mould part 2 is moreover shown in its position farthest away from the inlet mould part 1, it being in abutment on the end stop 12 at the one end of the outer pipe 5 of the distance-limiting device 19 on which the intermediate mould part 2 can be shifted.

As will appear from FIG. 2, the distance-limiting device 19 comprises, as mentioned, an outer pipe 5 which, at the one end comprises the end stop 12 and, at the other end, is secured to the inlet mould part 1 at the collar 13. Within the outer pipe 5 a rod 4 is displaceably arranged on which the shock absorber 6 is mounted at the one end in such a manner that the piston 16, when the intermediate mould part 2 abuts on the end stop 12, is pressed into the shock absorber housing, the abutment pin 7 in that position being in abutment on the piston 16 and such that, when the intermediate mould part 2 is shifted from the shown position in a direction towards the inlet mould part 1, the piston 16 is allowed to be shifted out of the shock absorber housing. A not shown spring is arranged in the shock absorber 6 to ensure that the piston 16 is shifted out of the shock absorber housing in the unloaded position of the shock absorber 6.

The abutment pin 7 is securely mounted in the outer pipe 5, but it can be shifted in the slot 18 on the rod 4 to the effect that the rod 4 can be shifted only a distance corresponding to the length of the slot 18.

On the closing mould part 3, a driver 10 is configured that has a driver head 20 having, in the shown position, let go of the intermediate mould part 2. The driver 10 and the driver head 20 are configured such that, when the injection-moulding mould is closed, which means that there is no space between the inlet mould part 1 and the intermediate mould part 2 and between the closing mould part 3 and the intermediate mould part 2, the driver 10 will, when the closing mould part 3 is, from that position, pulled away from the intermediate mould part 2, by a spring load, at the onset be pressed downwards to the effect that the driver head 20 presses the intermediate mould part 2 along with it, until a pin 9 on the driver 10 hits the ramp 8, whereby the driver head 20 is lifted clear of the intermediate mould part 2 and lets go of same just before the intermediate mould part 2 reaches the end stop 12 in the shown position

The shock absorber 6 thus mitigating the movement between the inlet mould part 1 and the intermediate mould part 2 over the last distance when they are shifted away from each other, it is thereby possible, other things being equal, to use increased speeds when opening the injection-moulding mould and ensuing reduced cycle times for each moulding process.

Moreover, the injection-moulding mould has a further shock absorber 11 which is configured in the closing mould part 3 and which mitigates the movement between the closing mould part 3 and the intermediate mould part 2 when they are pressed against each other.

Hereby noise and wear in connection with the closing of the injection-moulding mould are considerably reduced, and it is possible to operate at an increased closing rate.

1. An injection-moulding mould configured for being mounted in an injection-moulding apparatus for automated moulding of work pieces from plastics, said injection-moulding mould comprising at least three separate mould parts, comprising an inlet mould part in which is arranged an inlet for injection of liquid plastics from the injection-moulding apparatus, a closing mould part and at least one intermediate mould part arranged between the inlet mould part and the closing mould part, and which mould parts in pairs are separated by mould separation faces, and are configured for being capable of being shifted relative to each other along a straight line which is substantially at right angles to the mould separation faces which, in the closed state of the injection-moulding mould where the mould separation faces are in abutment on each other, form a number of mould cavities and, in the open state of the injection-moulding mould where the mould separation faces are pulled away from each other, allow form removal of work pieces moulded in the mould cavities by removal of any moulded work pieces from mould cavities that are thereby open into the space between the closing mould part and the intermediate mould part and moulded distributor elements, corresponding to distribution channels that are thereby open into the space between the inlet mould part and the intermediate mould part, and wherein, between the inlet mould part and the intermediate mould part, a distance-limiting device is configured that has an end stop configured with a view to limiting the distance by which the intermediate mould plate can be shifted away from the inlet mould part, characterised in that a shock absorber is further arranged between the inlet mould part and the intermediate mould part, said shock absorber being configured such that it mitigates the shifting movement between the inlet mould part and the intermediate mould part, when they are moved away from each other and before the end stop is hit.

2. An injection-moulding mould according to claim 1, characterised in that the shock absorber is built integrally with the distance-limiting device.

3. An injection-moulding mould according to claim 2, characterised in that the distance-limiting device comprises an outer pipe and a rod being arranged to be telescopically displaceable within the outer pipe.

4. An injection-moulding mould according to claim 3, characterised in that the shock absorber is arranged within the outer pipe.

5. An injection-moulding mould according to claim 1, characterised in that a shock absorber is further arranged between the closing mould part and the intermediate mould part, said shock absorber being configured such that it mitigates the shifting movement between the closing mould part and the intermediate mould part, when they are moved towards each other and only briefly before the injection-moulding mould is closed.
